(19) United States
(12) Patent Application Publication
(10) Pub. No.: US 2007/0097693 A1
(43) Pub. Date: May 3, 2007

(54) Light fixture with two-region light diffuser

(75) Inventor: Leonhard Klose, Ludenscheid (DE)

Correspondence Address: THE FIRM OF KARL F ROSS, 5676 RIVERDALE AVENUE, PO BOX 900, RIVERDALE (BRONX), NY, 10471-0900, US

(73) Assignee: ERCO Leuchten GmbH

(21) Appl. No.: 11/409,554

(22) Filed: Apr. 21, 2006

(30) Foreign Application Priority Data
May 9, 2005 (DE) 102005022054.1

(51) Int. Cl. F21V 7/00

(52) U.S. Cl. 362/307; 362/355; 362/360

(57) ABSTRACT

Described and shown is inter alia a light fixture (10) with a housing (11), in which a light source (15) is located and with a light outlet (23), wherein a diffuser element (18) is located in the light path between the light source and the light outlet.

The invention consists in the fact that the diffuser element for the generation of two different light cones (25, 27) has two regions (20, 21) with different transmission characteristics.

The invention initially relates to a light fixture according to the preamble of claim 1.

In particular the invention relates to a building light fixture, which means a light fixture fixedly installed on a building surface or on a surface of a building that can illuminate an exterior or interior room, for example a floor area, a wall or a ceiling area. It can as well be used, however, for the illumination of an object, for example of a piece of art. Particularly it relates to a light fixture to be installed on the ceiling, preferably in the manner of a ceiling-mounted recessed light fixture.

Light fixtures according to the preamble of claim 1 are known and widely used. The applicant has been producing them for years. A diffuser element located in the light path between the light source and the light outlet can for example be arranged directly in the light outlet of the housing or in the light path in front of the light outlet. The diffuser element can be formed by a glass plate and be provided with a certain roughness or structure created by sand blasting of the surface, so that the light rays are diffusely dispersed that leads to a homogenization of the light. Broader light distribution or improved homogenization is required in many applications. Moreover, by means of the diffuser element the high luminance of the lamp can be homogenized over the whole surface of the diffuser element so that the lamp e.g. cannot be that easily removed and the dazzling is reduced.

A light fixture according to the preamble of claim 1 is for example described in DE 196 32 665 A1 of applicant. There, a reflector light fixture according to the type of a ceiling-mounted recessed light fixture is shown that has rotationally symmetric reflector that has an lamp-holding chamber in its rear area, limited by a diffusely dispersing separate flat component designed like a pointed cone. This diffuser element is translucent and opaque, which means milk-glass-like.

Based on this state-of-the art it is the object of the invention to further develop a light fixture according to the preamble of claim 1 such that it has a simple design and can be variably used.

This object is solved by the invention by the features of claim 1, in particular by those of the characterizing part and is therefore characterized in that the diffuser element has two regions with different transmission characteristics for the generation of two different light cones.

According to the invention, the diffuser element can have two or more regions with different transmission characteristics for the light emitted by the light source. Thus, at least two different light cones can be generated. The different light cones differ from each other both regarding the type of light and regarding the radiation angle or generally regarding their radiating characteristic. For example a first, preferably central or inner light cone can be generated by a first region of the diffuser element that is for example composed of clear glass and therefore provides a direct, non-dispersed or more brilliant (so-called harder) light. A second, e.g. exterior light cone, generated by a second region of the diffuser element that for example is provided with a diffusely dispersing surface can generate a more diffuse, that is more homogeneous or more broadly dispersing light known from common diffuser elements and thus a light of a different type. The first, inner cone has e.g. in total a light with higher intensity, whereas the second cone has a light of lower intensity.

This way the two light cones can overlap. The first inner light cone is preferably designed more narrowly radiating than the second, exterior light cone overlapping with the inner light cone. In the case of an overlapping of the two light cones, these two light cones are generally perceived as one joint light distribution curve, wherein the joint light cone generated by the two light cones, that is the collective light distribution of the light fixture has a central, brighter area on its inside and a less bright area on its outside.

In certain applications, e.g. in sales rooms or show rooms a for example centrally located area can be more strongly illuminated by the light fixture according to the invention thanks to the light cone generated by the first region so that the goods or exhibited objects located within this light cone are distinguished and highlighted. Around this more intensely lit area, a more homogenous illumination can be provided by the second light cone that generally is perceived as agreeable light. If the light fixture according to the invention is recessed in the ceiling, a more homogenous illumination that is perceived as less disturbing because of its homogeneity but that still sufficiently lightens the room as a whole, can be achieved due to the different radiation angles, particularly when the distance from the floor is quite large.

Thus, it is possible to generate two different types of light with the light fixture according to the invention that have different functions. This is made possible by one single diffuser element that has two different regions with different transmission characteristics.

The diffuser element can be formed, for example, by a flat, planar or curved plate, particularly a glass or plastic plate. The second region can be produced by treating a surface region of the diffuser element or by inclusion of pigments or similar matters. For the surface treatment of glass plates, for example in order to form the diffuser element, sand blasting, etching or other structuring surface-treatment procedures can be considered. Diffuser elements in the sense of the invention are as well such basically translucent bodies that have prisms, lenses, holographic elements or the like and thus form a second region. The first region is preferably clear, but can also have a different transmission characteristic, e.g. in the sense of a focusing that differs from the transmission characteristic of the second region. For example, the first region can be formed by a different kind of surface-treatment method or have different prisms, different lenses or different holographic elements than the second area.

The diffuser element can be color-neutral or colored.

The light fixture preferably has one single light source that generates both of the different light cones. Preferably point-type light sources like (high-pressure) metal halide light fixtures, low-voltage halide light fixtures or high-voltage halide light fixtures are used. Likewise, also white or colored LED's can be used as light source. It is also possible to provide several light sources.

The term light cone in the sense of the invention means a light distribution curve with an optional profile, e.g. in the way of a truncated cone, the profile surface of which is determined both by the light outlet of the light fixture and of the reflector surfaces that might be provided in the housing. The light cone can have a circular-shaped profile like a truncated cone or alternatively a profile based on a traverse, e.g. a quadratic profile.

The diffuser element according to the invention can also have more than two regions for the generation of more than two different light cones. Preferably two regions for the generation of two different light cones are provided.

From DE 196 32 665 A1 of the applicant a diffuser element is already known that in the central area has a light inlet or finger opening. This is without any light-technical influence and cannot lead to the generation of light cones.

The invention furthermore relates to a light fixture according to the preamble of claim 2.

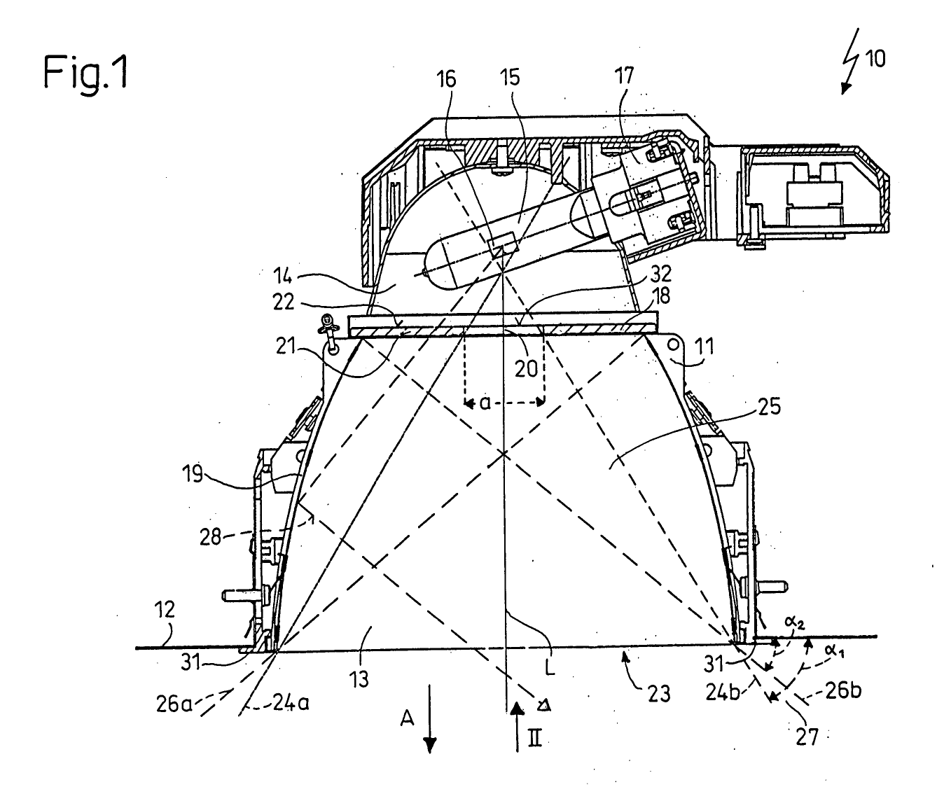

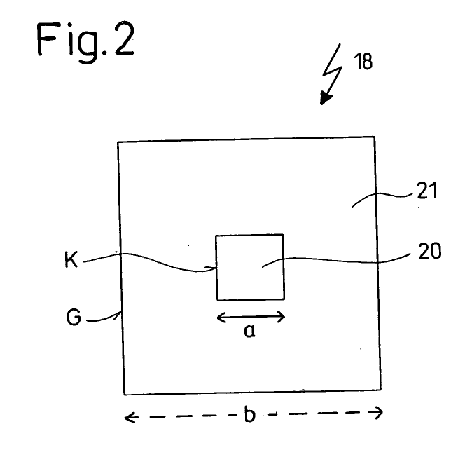

The invention again is based on the light fixture shown in FIG. 1 of DE 196 32 665 A1, where a diffuser element is located in the light path between light source and light outlet that completely covers the light source. The term “completely covers” means that all the light emitted by the light source and leaving the light fixture through the light outlet must pass through the diffuser element. Such a diffuser element is necessary for protection when certain light sources are used, in particular point-type light sources that can reach a high operational temperature. Such light sources, for example high-pressure metal halide light fixtures, low-voltage halide light fixtures or high-voltage halide light fixtures have to be covered for the protection of people in the room by at least on complete cover that has no direct openings. Diffuser elements with a finger opening as shown in FIGS. 2 to 4 of DE 196 32 665 A1 must not be used due to the legal regulations for such dangerous light sources or lamps.

The diffuser element completely covering the light source also has a protective function regarding light fixture defects and protects people in the room for example in case of an explosion of the light source in case of which for example glass parts could fly around. To achieve this protective function the diffuser element has a continuous design and completely covers the light source.

Based on a light fixture according to the preamble of claim 2 it is the object of this invention that the light fixture is further developed such that it has a simple design and can be used in different applications.

The invention solves this object by the features of claim 2, particularly by the features of the characterizing part and is therefore characterized in that the diffuser element has two regions with different transmission characteristics.

The principle of the invention is basically to separate a diffuser element completely covering the light source into two regions that have different transmission characteristics. The regions with different transmission characteristics are used in the manner explained above for the generation of two different types of lights. A first, for example central region of the diffuser element, which means a region basically located close to the central longitudinal axis of the light fixture, can be clear, for example because a glass plate forming the diffuser element has no treated surface in this first region. The light passing through the first region can thus be a more brilliant light, for example for the illumination of goods or objects. The second region, particularly a region surrounding the first region like a ring can commonly be a diffuser, for example by treating of a surface and provide a second light cone with a more homogenous light.

For better comprehension of the invention and also for reference to individual features reference is made to the above-mentioned descriptions of claim 1 in order to avoid repetition.

The invention further relates to a light fixture according to the preamble of claim 3.

It is therefore the object of this invention, based on a light fixture according to FIG. 1 of DE 196 32 665 A1 to further develop a light fixture according to the preamble of claim 3 such that it has a simple design and can be used in different applications.

The object is solved in the invention by the features of claim 3, particularly by those of the characterizing part and is therefore characterized in that the diffuser element has two regions with different transmission characteristics, wherein the ratio of the diameter or of the breadth of the first region to the total diameter or the total breadth of the diffuser element is between 1:5 and 2:3 approximately, preferably of approximately 1:3.

The invention is basically based on the fact that the diffuser element has two different coordinated regions that can generate different types of light, particularly different light cones. This can be achieved by treating the surface of a diffuser element preferably designed in one piece, wherein for example a central first region is clear and a second exterior region surrounding the first region like a ring has a surface treated by sand blasting that causes a diffusing effect.

If the design is circular, the first region can have a first diameter and the second region can have a second diameter in case of a corresponding circular design of the whole diffuser element. The ratio of the first diameter to the second diameter is between 1:5 and 2:3 approximately, preferably approximately 1:3. Thus, a first region is provided with a size that allows the generation of a respective light cone with a first type of light that differs from a second type of light of a second light cone, generated by the second region.

If the first region is not circular and the diffuser element is not circular, instead of the term “diameter” the term “width” is used, that is for example the edge length of the square in case of a square profile of the first region and of the whole diffuser element. Alternatively, instead of the edge length, the length of diagonals can be used. The ratio of the widths is as well between approximately 1:5 and 2:3, preferably approximately 1:3.

From FIGS. 2 to 4 of DE 196 32 665 A1 an air inlet or finger opening is known. The ratio of the diameter or the inner width of this finger opening to the complete inlet, however, is 1:6 to 1:7 and is thus significantly smaller and not adequate for the generation of a light cone of a individually recognizable type of light.

For better comprehension of the invention and also for reference to individual features reference is made to the above-mentioned descriptions of claim 1 in order to avoid repetition.

According to an advantageous embodiment of the invention the two regions generate different types of light. For example the first region can generate a brilliant light and the second region a harmonized, more diffuse light.

According to a further advantageous embodiment of the invention the two different types of light have different coordinated shielding angles. That means that the light fixture in total can have a shielding angle of for example 40°. In this case, a person outside of the illuminated region, in an angle of about 40° or less in relation to the ceiling, cannot recognize the light source at all. Goods or objects located within an e.g. 60° light cone are illuminated by the brilliant light and are thus highlighted. A room region between 40° and 60° in relation to the ceiling is exclusively lit by the second light cone generated by the second region and having a more homogenous light that leads to an agreeable and more purpose oriented illumination. The numbers indicated for the shielding angles obviously are only exemplary and can vary according to the field of application.

The two light cones can have different cone angles, wherein preferably the inner, central first light cone radiates narrowly and has an cone angle (e.g. according to FIG. 1 of the present patent application) of for example 63°, whereas the second light cone radiating a more diffuse light can have an cone angle of for example 100°. The cone angle of the light cone is determined by the geometry of the reflector, the diameter or the width of the first region, the diameter or the width of the diffuser element and the position of the light source.

According to a further advantageous embodiment of the inventions, the diffuser element is basically translucent and can only partially disperse, direct or focus the light passing through it. The first region of the diffuser element allows direct passage of the light emitted by the light source without this light being dispersed, directed or focused, whereas the second region can have the common function of a diffuser element in the sense of light dispersion, direction or focusing.

According to a further advantageous embodiment of the invention, the first region of the diffuser element basically lets the light pass through without influencing it, wherein the second region of the diffuser element disperses the light. This allows the generation of a first light cone of a first type of light, for example of a harder, more brilliant light and the generation of a second light cone of a second type of light with a more homogenous light.

According to a further advantageous embodiment of the inventions, the first region of the diffuser element is basically centrally located on the diffuser element. This basically allows a rotationally symmetric, in any case symmetric design of the light fixture and the achievement of a corresponding symmetric light distribution characteristic of the light fixture.

According to a further advantageous embodiment of the inventions, the second region of the diffuser element surrounds the first region like a ring. This allows a particularly simple production of the diffuser element and a simple design, as well as using a reflector element located in the light path behind the diffuser. The reflector element and/or the light outlet can be adapted in their diameter to the diameter of the diffuser element.

According to a further advantageous embodiment of the inventions, the second region of the diffuser element is obtained by a surface-treatment procedure. This allows a particularly easy production of the diffuser element according to the invention.

According to a further advantageous embodiment of the inventions, the light source is basically point-type. Thus the light distribution curve of the light fixture can be very exactly predetermined.

According to a further advantageous embodiment of the inventions, the light fixture has a reflector element. This allows a direct light direction, particularly of the light region passing through the second region of the diffuser element.

According to a further advantageous embodiment of the inventions, the reflector element is located in the light path between the diffuser element and the light outlet. This allows an optimized aiming of the light.

According to a further advantageous embodiment of the inventions, the light source is located and positioned relative to the first region of the diffuser element that the light regions passing through the first region, at least for the most part, leave the light fixture by the light outlet without having been reflected by the reflector. Thus, the light distribution curve of the light fixture can be further optimized.

According to a further advantageous embodiment of the inventions, the light source is located and positioned relative to the second region of the diffuser element such that the light regions passing through the second region, at least for the most part, leave the light fixture by the light outlet only after having been reflected by the reflector. This allows a further optimized light distribution of the light fixture.

The diffuser element can be formed by a flat body that is planar or basically curved. This allows use of common bodies, for example used in the state-of-the-art as cover lens, like glass plates or polyacrylic bodies or other plastic elements.

According to a further advantageous embodiment of the invention, all the light passing through the light outlet has passed the diffuser element before. This allows a further optimized light distribution curve of the light fixture.

Further advantages of the inventions result from the not cited dependent claims as well as from the following description of the embodiments shown in the drawings. Therein:

FIG. 1 is a first embodiment of a light fixture according to the invention in a schematic sectional view,

FIG. 2 shows the diffuser element of the light fixture all alone according to the invention in a schematic bottom view according to arrow II in FIG. 1,

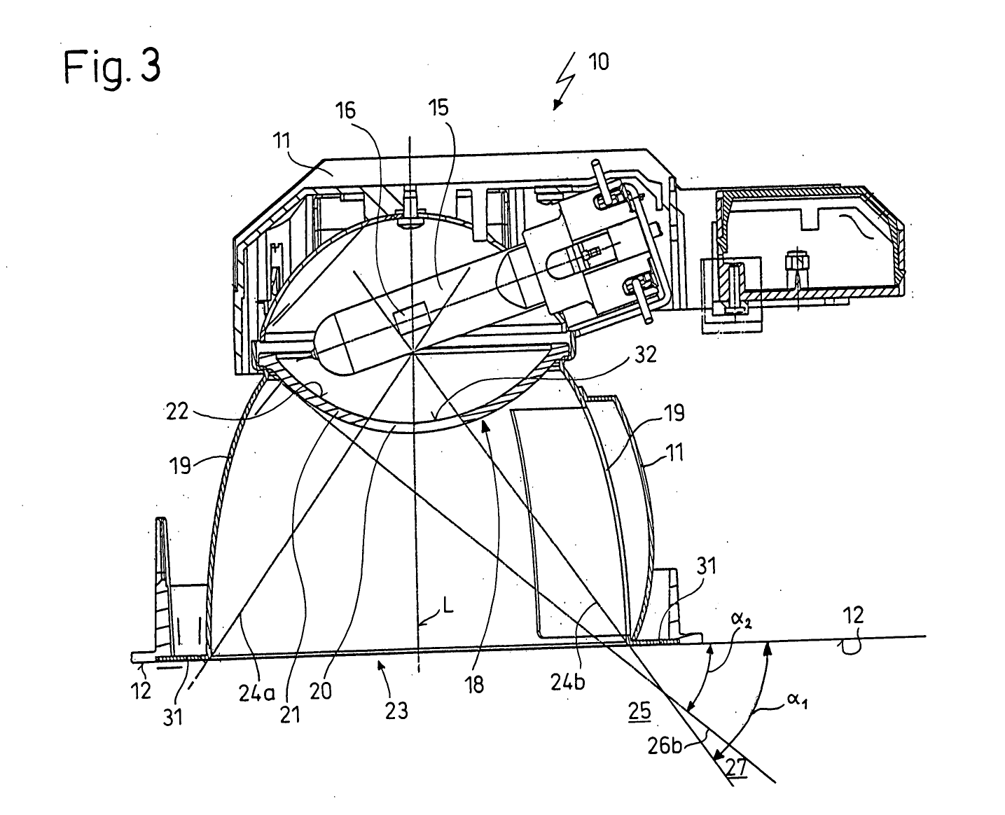

FIG. 3 shows a second embodiment of the light fixture according to the invention in a view like FIG. 1, and

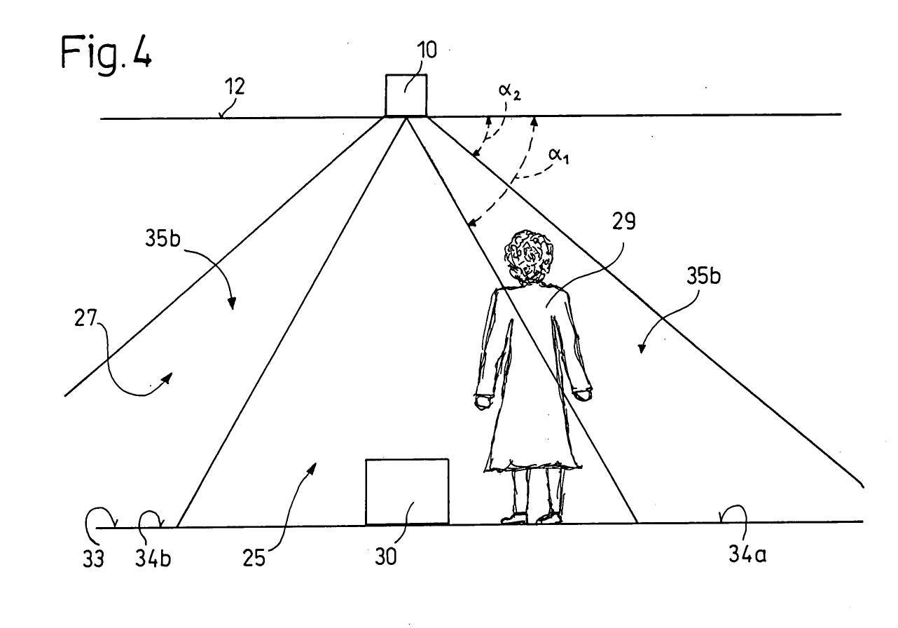

FIG. 4 is the light fixture according to the invention when recessed in the ceiling with two different light cones and showing a person.

The light fixture as a whole indicated with 10 is to be described by means of FIG. 1. It should be noted that for reasons of clarity in different embodiments the same or similar parts or elements have the same reference signs in the figures, partially with lower-case letters added.

FIG. 1 shows a light fixture 1 with a longitudinal central axis L that can also be the symmetry axis of the light fixture 10. The longitudinal axis L also determines the main radiation direction A of the light of the light fixture and in a certain way acts as optical axis.

The light fixture 10 according to FIG. 3 can be located rotationally symmetric around its longitudinal center axis L or as is the case in the embodiment of the FIGS. 1 and 2, be only symmetrically located to this axis and have in total a rectangular or rectangular periphery, maybe also a diverging shape. Preferably the light fixture has peripheries of the light outlet, the reflector element, the diffuser element and the outside shape that are similar to each other and of a first and a second region as described in the following as it is the case in the embodiments shown in the figures.

The light fixture according to FIG. 1 comprises a housing 11, the free marginal area 31 of which basically is flush with a ceiling 12 of a room. The light fixture is thus designed as a ceiling-mounted recessed light fixture. In further unillustrated embodiments, the light fixture according to the invention is designed as a ceiling-mounted recessed light fixture or wall light fixture, a pendant light fixture or the like.

The housing 11 defines an inner area 13 and a separate holding chamber 14 for holding a lamp 15 serving as light source. Preferably point-type light sources are used, that is such light sources that only have a very small lighted space 16, such as for example metal halide light fixtures, low-voltage halide light fixtures or high-voltage halide light fixtures.

The lamp 15 is fastened in a socket 17 in an upper housing area. The connection wires and maybe existing operating devices, cooling bodies and the like are not further described.

The lamp-holding chamber 14 and the interior 13 of the light fixture 10 are separated from each other by a diffuser element 18. The diffuser element of the embodiment of the FIG. 1 consists of a basically rectangular, planar or flat glass plate and is illustrated in FIG. 2. The diffuser element 18 has a first region 20 centrally located at the inside and with an edge length a, thus with a corresponding width a. The rectangular diffuser element 18 in total has an edge length b with a corresponding width b. The second region 21 surrounds the first region 20 like a ring, this ring also having a rectangular outer periphery.

The surface 22 of the region 21 of the diffuser element 18 facing the light source 15 was roughened or structured by sand blasting or any other comparable surface-treatment procedure.

The diffuser element 18 with the first region 20 and the second region 21 in total has a continuous design. The hatching in FIGS. 1 and 3 of the second region 21 of the diffuser element 18 indicates different transmission characteristics. The region 21 acts as diffuser while the first region 20 is clear and has a surface 32 that is not sand-blasted facing the light source 15. Contrary to the known light fixture of the FIGS. 2 to 4 of the DE 196 32 665 A1, the central first region 20 is as well part of the diffuser element 18 and consists e.g. of glass or plastic. The first region 20 in the embodiment of FIGS. 1 and 3 in any case is not an inlet opening, but filled with material.

The geometric configuration according to FIG. 1 results causes light rays emitted by the luminous volume 16 of the lamp 15 to pass partially through the first region 20 of the diffuser element 18 and directly leave the light outlet 23 of the light fixture 10 in this case without having been reflected by a reflector element 19. This direct-light regions are indicated at edge rays 24a and 24b and generate a first light cone 25 of a first type of light, that is a more brilliant or harder light. This light cone has a shielding angle α₁ in relation to the ceiling 12 of about 60°, for example.

The light region of the light emitted by the light source 15 passing through the second region 21 of the diffuser element 18 is at first diffusely dispersed, subsequently reflected by the inner side of the reflector element 19 and leaves the light outlet 23 of the light fixture only after reflection by the reflector 19. The exemplary light ray 28 in FIG. 1 clarifies such a typical light path. The marginal rays of the light passing through the second region 21 of the diffuser element 18 are indicated with 26a and 26b in FIG. 1 and define a second broader light cone 27 with a bigger cone angle of about 100° that has a different type of light, namely a more homogenous and more diffuse or dispersed light. It is to be noted that all the light regions of the light emitted by the light source passing through the second region 21 of the diffuser element 18 are reflected by the reflector 19 and leave the light fixture 10 only after reflection by the reflector element 19.

FIG. 4 shows a schematic view of a light fixture 10 fastened at the ceiling 12 illuminating a floor area 33. The first light cone 25 that is generated by the central first region 20 of the diffuser element 18 can generate brilliant light and distinguish, highlight or in any case brightly illuminate for example an object, located on an indicated shelf 30 within the light cone 25. The second light cone 27 generating a more homogenous light can provide a more agreeable light for other areas of the room and for example lighten the regions 34a and 34b of the floor area and room regions 35a and 35b adjacent the floor area 33 with a more homogenous light.

FIG. 4 clearly shows that the shielding angle α₂ of the second light cone 27 is smaller and of for example 40°. If a person indicated with 29 in FIG. 4 is situated within the light cone 25, which might not be desired and is not shown in FIG. 4 since this light cone basically illuminates the display, goods, objects or the like, the person would be illuminated with very intense light. If the person 29 is situated within the second light cone 27 but outside of the first light cone 25 as shown in FIG. 4 the light generated by the second region 21 would be considered as agreeable and not disturbing and the person could for example look at the display located on the shelf 30 without disturbance and with the room being optimally illuminated.

If, as not shown in FIG. 4, the person 29 is situated outside the second light cone 27, that is within a smaller angle than 40° in relation to the ceiling 12, the person would not be blinded, as no direct sight connection to the lamp 15 is possible. On the other hand, the person outside of the second light cone 27 perceives the whole room illumination as agreeable.

The degrees given for the shielding angle α₁, α₂ obviously can be optionally chosen. In the same way, a plurality of light fixtures 10 can be located on a ceiling of a building 12, the individual light cones 25, 27 also overlapping if necessary, such that for example the effect is achieved as well, that the floor surface 33 as a whole or for the most part is illuminated very brightly and intensely with brilliant light and most of the room areas at a certain distance from the floor area 32, for example at a height of 2 m, are illuminated for the most part by more homogenous light.

FIG. 3 shows a further embodiment of the light fixture 10 according to the invention that differs from the embodiment of FIG. 1 basically regarding a changed design of the diffuser element 18 that is curved, that is for example spherically arcuate. Again, an inner central first region 20 is provided that basically lets light pass through without influencing it and generates a light cone 25 and a second region 21 surrounding the first region 20 like a ring and commonly acting as diffuser and generating a second light cone 27.

It should be noted that the ratio of the width a of the first region 20 of the diffuser element 18 to the width b of the whole diffuser element 18 in the region is 1:5 to up to 2:3. The embodiments of the FIGS. 1 and 3 approximately show a ratio of the width a to the width b of the whole diffuser element 18 of about 1:3. If the diffuser element 18 is arcuate, the width or diameter is to be considered that part of the first region 20 that results from the projection of the diffuser element 18 on a plane perpendicular to the longitudinal axis L.

The transmission characteristics of the first region 20 and of the second region 21 are different insofar as the light region passing through the first region 20 passes through unhindered by the light source 15, which means basically in an undirected and basically undispersed way and thus particularly the light cone is not fanned out or focused. The second region 21, on the other hand, should precisely serve for the harmonization, fanning out or the direction as well as sometimes for the focusing of the light region passing through the second region 21. This diffusing effect of the second region 21 can be achieved by treating the surface of the side 22 of the second region 21 facing the light source or alternatively by treating the side of the second region 21 directed away from the light source 15. Alternatively it is also possible that an existing diffuser element with for example a completely roughened surface has a surface that is treated in the first region 20 such that the side 32 of the first region 20 facing the light source is smoothed and thus a clear-glass design of the first region 20 is obtained. In the same way pigments, dispersing bodies or such like can be integrated into the diffuser element 18 in the region 21 or be integrated in the diffuser element during production.

Preferably the diffuser element 18 is produced and designed in one piece. It is also possible, however, that the diffuser element 18 consist of two pieces or elements or has an opening in the central region 20 that should be avoided for reasons of protection and safety particularly if the afore-mentioned point-type lamps that can reach high temperatures are used.

The second region 21 of the diffuser element 18 can be formed by lenses or prismatic elements or by holographic structures. In the same way, the second region 21, as well as sometimes also the first region 20 can be colorless or tinted or colored, wherein differently colored tints are possible, too. Both the colored tints and the diffusing effect can be achieved by gluing on a foil or by fastening of comparable elements on one exterior side of the diffuser element 18, it being also possible to provide the different regions 20, 21 with different foils.

The orientation and size of the first region 20 is such that light from the lamp 15 cannot fall directly on the reflector element 19. Thus uncontrolled reflections can be avoided with a simple design.

Advantageously, the first region 20 has an outer shape K corresponding to the total outer shape G of the diffuser element 18 or to the outer shape of the light outlet 23. It should be noted that in the embodiment of FIG. 1 the light outlet 23 also has a rectangular shape. In the embodiment of FIG. 3 the light outlets 23, the outer shape of the first region 20 and the outer shape of the diffuser element 18 have a circular shape.

The light source is e.g. a metal halide lamp e.g. a HIT-TC-CE according to the ZVEI-denomination (ZVEI=Zentralverband der Elektrotechnischen Industrie, central association of the electrical industry).

The first light cone 25 is preferably narrower than the light cone 27 and is completely surrounded by the latter. In the area of the first light cone 25 the light is added, the light cone 25 due to the bigger luminous flux being dominated basically by the more brilliant, direct light generating starker shadows.

The invention makes it possible to achieve two different light qualities by means of a single light fixture and a single light source with a very simple design. This way the diffuser has two different dispersion areas.

Further additional light guiding or light directing elements, glasses, mirrors or the like that are not shown in the figures can be provided on the light fixture.

1. A light fixture (10) with a housing (11) in which a light source (15) is located and with a light outlet (23), wherein a diffuser element (18) is located in the light path between the light source and the light outlet, characterized in that the diffuser element has two regions (20, 21) with different transmission characteristics for the generation of two different light cones (25, 27).

2. The light fixture (10), in particular according to claim 1 with a housing (11) in which a light source (15) is located and with a light outlet (23), wherein a diffuser element (18) is located in the light path between light source and light outlet that completely covers the light source, characterized in that the diffuser element has two regions (20, 21) with different transmission characteristics.

3. The light fixture (10), in particular according to claim 1 with a housing (11) in which a light source (15) is located and with a light outlet (23), wherein a diffuser element (18) is located in the light path between light source and light outlet, characterized in that the diffuser element has two regions (20, 21) with different transmission characteristics, wherein the ratio of the diameter or of the width (a) of the first region (20) with the total diameter or the total width (b) of the diffuser element (18) is between 1:5 and 2:3 approximately, preferably approximately 1:3.

4. The light fixture according to claim 1, characterized in that the two regions (20, 21) generate different type of lights (25, 27).

5. The light fixture according to claim 4, characterized in that the two different type of lights have different coordinated shielding angles (α₁, α₂).

6. The light fixture according to claim 1, characterized in that the diffuser element (18) is basically translucent and can only partially disperse, direct or focus light passing through it.

7. The light fixture according to claim 1, characterized in that the light basically passes through the first region (20) of the diffuser element (18) without being influenced and that the second region (21) diffusely disperses the light.

8. The light fixture according to claim 1, characterized in that the first region (20) of the diffuser element (18) is basically located in a central position on the diffuser element.

9. The light fixture according to claim 1, characterized in that the second region (21) of the diffuser element (18) surrounds the first region (20) of the diffuser element like a ring.

10. The light fixture according to claim 1, characterized in that the diffuser element (18) is composed of glass.

11. The light fixture according to claim 1, characterized in that the first region (20) of the diffuser element is clear.

12. The light fixture according to claim 1, characterized in that the second region (21) of the diffuser element is obtained by treating the surface (22), particularly by sand blasting or etching.

13. The light fixture according to claim 1, characterized in that the light source (15) is basically a point source.

14. The light fixture according to claim 1, characterized in that the light fixture has a reflector element (19).

15. The light fixture according to claim 14, characterized in that the reflector element (19) is located in the light path between the diffuser element (18) and the light outlet (23).

16. The light fixture according to claim 14, characterized in that the light source (15) is located and positioned to the first region (20) of the diffuser element (18) such that the portions of light passing through the first region (20), at least the predominant part leaves the light fixture by the light fixture outlet (23) without having been reflected before by the reflector element (19).

17. The light fixture according to claim 14, characterized in that the light source (15) is located and positioned relative to the second region (21) of the diffuser element (18) such that the portions of light passing through the second region (21), at least the predominant part, leaves the light fixture (10) by the light outlet (23) only after the reflection by the reflector element (19).

18. The light fixture according to claim 1, characterized in that the diffuser element (18) is formed by a flat body (FIG. 1, FIG. 3).

19. The light fixture according to claim 18, characterized in that the body is basically planar (FIG. 1).

20. The light fixture according to claim 18, characterized in that body is basically curved (FIG. 3).

21. The light fixture according to claim 1, characterized in that all the light passing through the light outlet (23) has passed through the diffuser element (18) before.
